(19) United States
(12) Patent Application Publication
(10) Pub. No.: US 2007/0143708 A1
(43) Pub. Date: Jun. 21, 2007

(54) Overloaded hyperlink

(75) Inventor: Johan C. Peters, Sankt Leon-Rot (DE)

Correspondence Address: KENYON & KENYON LLP, 1500 K STREET N.W., WASHINGTON, DC, 20005, US

(73) Assignee: SAP AG

(21) Appl. No.: 11/305,071

(22) Filed: Dec. 19, 2005

(51) Int. Cl. G06F 9/00

(52) U.S. Cl. 715/821

(57) ABSTRACT

A user interface containing overloaded hyperlinks. The interface contains hyperlink areas containing a first hyperlink that is accessible in the hyperlink area. Second hyperlinks are indicated by emphasis on certain hyperlink displays and accessible through single or compound commands. The interface system is able to recognize location of operator input and relate them to corresponding processes.

### BACKGROUND OF THE INVENTION

As computers have increased in speed, storage and general processing capability, computer programs have also grown in complexity. Computer operators (e.g. users) often work with very large data sets and computer applications that provide a complex set of functionality. Computers typically present information to operators and receive commands therefrom through a user interface. Application designers often attempt to develop user interfaces that present information to operators with little visual clutter. Doing so facilitates convenient review of large data sets because an operator is able to scan the data set and identify relevant information quickly. Application designers, however, also attempt to develop user interfaces that provide ready access to application features. For example, a user interface may include various buttons, key commands, pull down menus and other command pathways that permit an operator to input a desired command. The complexity of many applications, however, often leads to a correspondingly complex system of command pathways. For example, an operator may be required to traverse several menu paths in order to identify a single command. These menus and windows obscure clean presentation of application data; they are clutter themselves.

One such user interface relies on hyperlinks as a mechanism to enter operator commands to a computer. In browsing applications, for example, hyperlinks provide a mechanism for navigational control and, increasingly, functional control. Implementations vary but, typically, a hyperlink is represented on a browser page by the “hyperlink display”—a text string, an image, a video or some graphical representation of control (arrows, buttons, etc). The hyperlink display occupies a spatial area of the browser page. When an operator interacts with the hyperlink display, for example, by bringing a cursor over the hyperlink display and clicking upon it, the browser interprets the interaction as a command to follow the hyperlink. The hyperlink includes a “target link,” which addresses a network resource, such as information content or application functionality to be invoked. The browser sends a request to retrieve the identified information content, which is delivered to the browser and rendered for display as a page, or to invoke the associated functionality. The newly rendered page may have other hyperlinks, which invoke other content or functionality.

Typically, initiating a single transaction requires a single input, such as a hyperlinked text. To display a robust set of functionality in a single browser page, however, a page becomes increasingly cluttered and hard to read. Accordingly, there is a need in the art for a user interface that displays related information together without requiring repetition of text or multiple layers through different webpages to access more menus or hyperlinks. The embodiment groups accessible processes into a single text area consisting of multiple hyperlinks overlapping a primary hyperlink. In more complex embodiments, emphasis may be added to help the operator locate and understand the functionality of the overlapping hyperlinks. Furthermore, hot spots, areas which an operator can activate in the embodiment, may not overlap completely.

### BRIEF DESCRIPTION OF THE DRAWINGS

FIG. 1 illustrates the hardware configuration capable of utilizing an embodiment.

FIG. 2 depicts a sample screenshot of an embodiment.

FIG. 3 displays hot spot areas for activation of second hyperlinks.

FIG. 4 displays a variation of the location of a hot spot for activation of second hyperlinks.

FIG. 5 displays an embodiment that has multiple secondary hyperlinks.

FIG. 6 displays a tooltip associated with a secondary hyperlink.

FIG. 7 depicts a system and an overview of the input/output of the system.

FIG. 8 depicts the logic to run and display an embodiment.

FIG. 9a provides a hypothetical markup language that could be parsed by an embodiment of the interface to display an overloaded hyperlink.

FIG. 9b displays the interface of the parsed hypothetical markup language containing overloaded hyperlinks.

FIG. 9c provides another variation of a hypothetical markup language that could be parsed by an embodiment of the interface to display an overloaded hyperlink.

FIG. 10 depicts a potential menu for an operator to change emphasis preferences in an interface.

FIG. 11 displays the logic for displaying the emphasis to alert the operator to hyperlink availability and for accessing processes associated to overloaded hyperlinks.

### DETAILED DESCRIPTION

Embodiments of the present invention provide an interface enabling an operator to access multiple processes in overlapping hyperlink areas. Furthermore, the interface is adaptable to provide different kinds of emphasis to alert an operator to the availability of multiple functionality in a hyperlink area. Tooltips may also be displayed to provide even more information about the additional hyperlinks. While a user interface design may already contain various types of emphasis, the embodiment is flexible and may allow an operator to change settings to alter emphasis corresponding to the hyperlinks. The interface may be displayed for a computer application, web application, or for web pages. The interface may be compatible with different types of programming languages or markup languages.

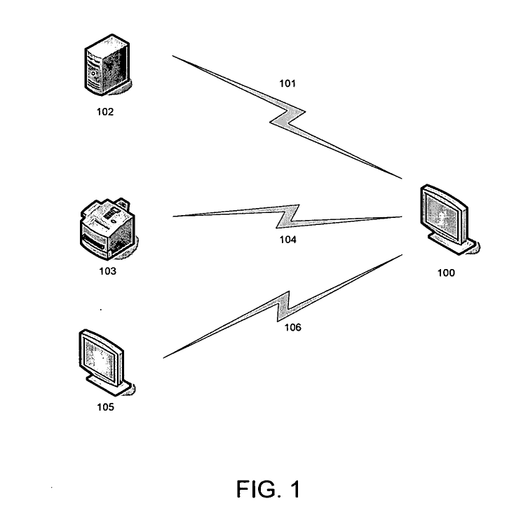

FIG. 1 illustrates a hardware configuration capable of utilizing an embodiment. A terminal 100 is connected to other computing hardware 102, 103, and 105 via a communication medium 101, 104, and 106, respectively. The terminal 100 can be any of a number of known computing devices, including a computer, a handheld computer or personal digital assistant (PDA), cellular phones, etc., but for convenience is simply represented by a display. The terminal 100 may include a browser application or any other type of application. The application can access data, content, or processes on multiple systems or on the terminal 100 itself. Any application can access content or processes through a plurality of servers 102, any number of peripheral hardware devices 103, or any number of other terminals 105 (only one of each is shown for convenience).

As one skilled in the art is aware, servers 102 have a multitude of functionality, including running applications, accessing databases, storing web pages, or performing any computational functionality. The peripheral devices 103 could include a fax machine, printer, modem, media player, camera, etc. The communication medium 101, 104, and 106 can consist of an intranet or internet access over a physical communication line, wireless access, or any other type of communication connection, such as USB or firewire, depending on the location and type of the hardware. The terminals 100/105, servers 102, devices 103 and applications thereon may be addressed via universal resource identifiers or uniform resource locators (URLS) according to common practice.

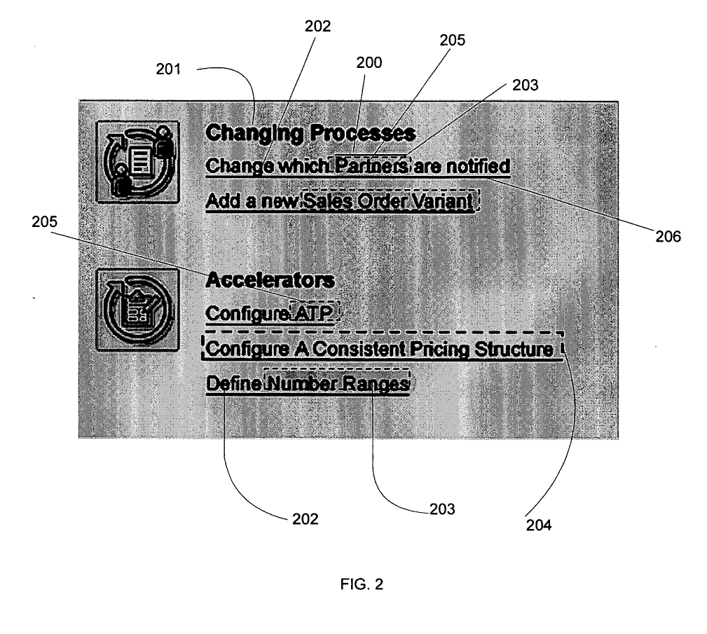

FIG. 2 is a screenshot of an exemplary page that may be rendered by a browser according to an embodiment of the present invention. As is typical, a rendered page may include text and/or image content (including animated images). Certain elements may function as hyperlink displays for one or more hyperlinks. According to embodiments of the present invention, an element 203 can serve as hyperlink displays for multiple hyperlinks. For example, the rendered text “Partners” may operate as a hyperlink display for two hyperlinks. In the rendered page, the presence of hyperlinks is shown with different forms of emphasis 200, 205, and 206. A first hyperlink is shown in the form of underlining 206 and extends throughout the entire clause “Change which Partners are notified.” A second hyperlink is shown in the form of overlining 200 and extends only for the word “partner.” Thus, two hyperlinks are associated with a common hyperlink display but they are displayed with different types of emphasis. By having the two hyperlinks overlap, an operator immediately is aware that the functions associated with the hyperlinks are related. Furthermore, by condensing hyperlinks in this fashion, a user interface is provided with comparatively less clutter than would be achieved by an interface that provides a long list of hyperlinks or lists redundant hyperlinks.

There is no requirement that the first and second hyperlinks refer to network resources that are related. In theory, if useful for an implementation for which the present invention is to be used, the hyperlinks could refer to vastly different resources. Of course, in many applications, the present invention may find use in circumstances where the first and second hyperlinks refer to related resources. For example, a first hyperlink may be provided as part of a navigation path in a larger workflow or transaction. By clicking upon the hyperlink display in a manner that activates the first hyperlink, the browser may be directed to another page, which represents another stage in a larger transaction. By clicking upon the hyperlink display in a manner that activates the second hyperlink, the browser may be directed to a page that, for example, provides contextual information about the next transaction stage for training purposes.

While overlapping hyperlinks may access a separate computer process, the separate processes need not be unique. For example, the primary hyperlink may access a webpage while an overlapping second hyperlink may access the same webpage but at a different section.

Any process requiring a browser-supported user interface would be able to utilize the embodiment. These processes may include a webpage viewable through a web browser or a software application. The sample interface of FIG. 2 has pure text 201 elements that do not have associated functionality. The interface also has hyperlink displays 202 common to many Hypertext Markup Language (HTML) webpages found on the internet. The hyperlink displays 202 of the embodiment have emphasis that operators would typically associate as having hyperlink functionality. The hyperlink displays 202 may commonly be underlined 206 and in blue-colored font, but due to the multitude of overlapping hyperlinks, an interface designer may vary the appearance of any of the hyperlinks.

In one embodiment, the added functionality of overlapping hyperlinks may include some type of emphasis. While experienced operators of an interface may not need emphasis to understand functionality on an interface, novice operators may find emphasis helpful to learn the various functions of an application interface or web application. The emphasis may be any stimulus to alert the operator to the location and the availability of a secondary hyperlink. In the embodiment, the emphasis may be a line above the text 200 (or an overline) or highlighting 205 the text (highlighted areas are outlined in a dotted box, in this figure only, for emphasis) to represent a second available hyperlink. A first hyperlink display 202 and second hyperlink display 203 would typically be located in an area known as the hyperlink area 204, though other hyperlinks may be accessible outside the hyperlink area 204 as will be described in later figures.

There are many types of emphases that could alert an operator to multiple hyperlink functionality which are not limited to an overline or highlighting, such as changing the color of the font, changing the background color, or altering the text. Altering the text could include flashing the text or even changing the actual words of the text. Emphasis alerting the operator could also be auditory, for example, a bell sound or sound clip with a description of the functionality of the second link. Emphasis could even be olfactory in nature. Emphasis could also be haptic feedback, such as tactile or force feedback on a peripheral device. For example, emphasis could be the vibration of a mouse. Overlapping hyperlinks could also be multiplexed in time, for example, the hyperlink display “Partner” could be displayed in a red font and over time change to a blue font and then back to a red font again or even to a third font color.

The type, timing of the display, and appearance of emphasis may be altered depending on the design of the interface. The embodiment may be adaptable to be able to display emphasis in any number of configurations. For example, it is possible that text is highlighted 205 and overlined 200 when the user interface is first displayed to an operator. It is also possible for text to be highlighted 205 initially and for the overline 200 to only appear when a cursor is placed over the secondary hyperlink. In addition, emphasis can be used singly to represent only each additional hyperlink or there can be multiple emphases for particularly important hyperlink functionality. For example, as in the previous example, a secondary hyperlink could be represented by a yellow highlight and a yellow overline while a tertiary hyperlink could be represented by a green highlight, blue overline, and a sound clip. One skilled in the art would be able to realize the multiple permutations of emphasis that could be available to display to the operator or to be activated when a cursor moves over a particular hyperlink. After continued use of an interface, an interface designer may potentially provide an expert interface for proficient operators or an option for an operator to turn off some emphasis after the operator becomes accustomed to the interface.

The advantage of having compound command functionality is that while functionality on each hyperlink is overloaded, visual display to the operator is not. For example, if there were twenty processes needed, it could require an operator to traverse through twenty different menus before being able to access the needed functionality. In the present embodiment, the twenty processes could be located in five hyperlink displays within the hyperlink area with each hyperlink display having four processes associated with four compound commands, as explained below.

Embodiments of the present invention permit an operator to select among multiple hyperlinks by using compound commands. Typically, an operator enters a simple command upon a single link hyperlink display (e.g., clicking on it) to activate the underlying hyperlink. In one embodiment, the present invention accommodates a hierarchy of command alternatives to differentiate among links. A direct click upon an hyperlink display may follow a first link. A compound command (e.g., CTRL+click) may activate a second hyperlink. Alternatively, clicks of left mouse buttons and right mouse buttons might be used to select a first or second link, respectively.

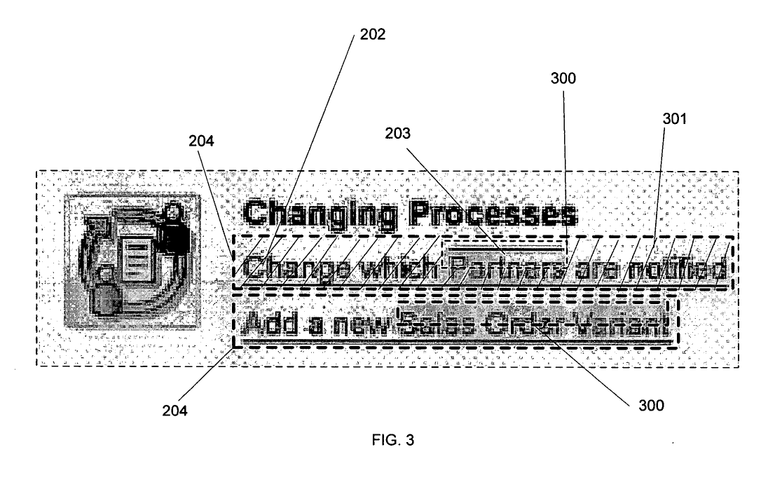

FIG. 3 depicts potential hot spots, areas which an operator can activate in the embodiment, which indicate to an operator the areas which are “clickable” in order to activate various hyperlinks within the hyperlink display. These hot spots areas may also be activated using a cursor click but may potentially be activated using other input mechanisms, such as tabbing through the page until the hyperlink is highlighted and pressing the “Enter” key-on the keyboard. A first hyperlink display 202 is depicted along with a second hyperlink display 203 which is highlighted to indicate multiple hyperlink functionality. Rectangular boxes indicate hot spots of second hyperlinks 300 which are within the general hyperlink areas 204. In FIG. 3, the second hyperlink hot spot 300 is a sub-area of the hyperlink area as well as a sub-portion of the text. The second hyperlink hot spots 300 are located in the upper portion of the text; however, the hot spots 300 may be located in any area and be of any size. The hot spot of the first hyperlink 301 would be the striped area located within the hyperlink area 204 but outside of the sub-areas of the hot spots of the secondary hyperlinks 300.

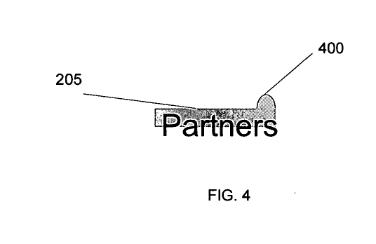

FIG. 4 depicts another possible variation where the highlighting 205 indicates the availability of a second hyperlink, and a “hot spot” tab 400 extends out so that it is clickable with greater ease.

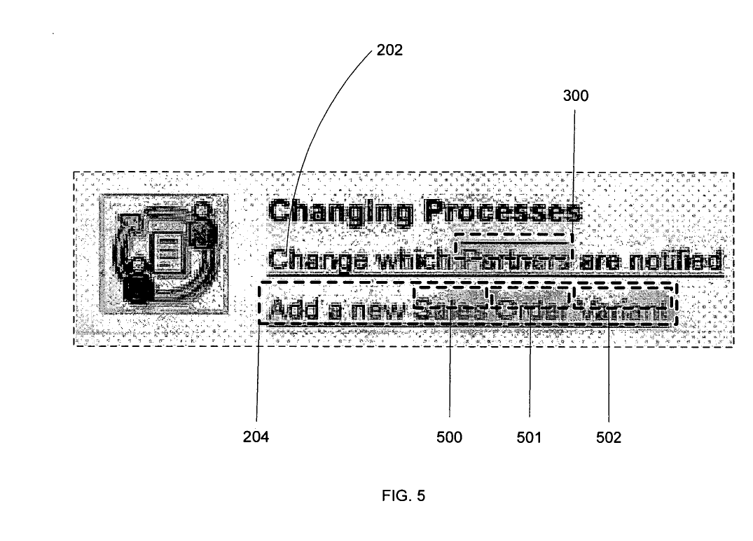

FIG. 5 depicts a hyperlink area 204 with three overlapping hyperlinks displayed by their hot spots 500, 501, and 502. In the embodiment a hyperlink area 204 would be capable of having n number of overlapping hyperlinks. Having too many hyperlinks may at some threshold number confuse the operator as to hot spot areas and also make hot spot areas too small; however, this problem may be resolved given the multitude of types of emphasis available and by using various force field techniques (e.g. fields that attract a cursor as it approaches a clickable area). For example, if there were multiple overloaded hyperlinks such that it would cause difficulty for a user to indicate the appropriate hot spot area, a force field could be used such that as a user moves from secondary link to secondary link, the cursor could be pulled, much like a gravitational pull, from one secondary hyperlink to the other, or, as another example, the cursor could “snap” from secondary hyperlink to secondary hyperlink.

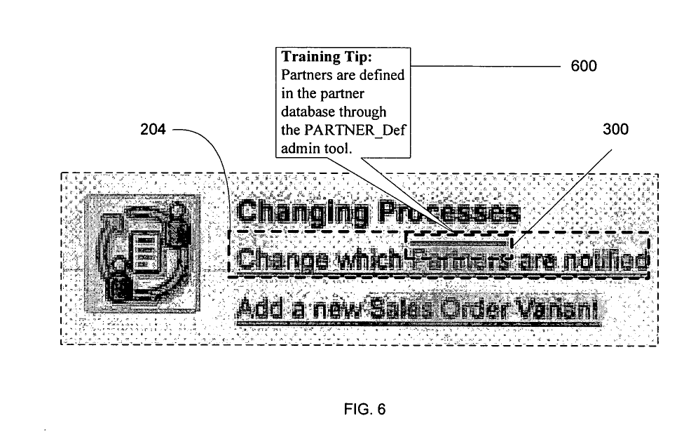

FIG. 6 depicts the hyperlink area 204 and the secondary hyperlink hot spot 300. An extension to the embodiment is to display a tooltip 600 when the operator is unfamiliar with the application of the hot spot. The operator may call up a tooltip 600 by moving a cursor over the hot spot area for a predetermined time which prompts the interface to display a box with information inside. However, one skilled in the art will understand that a tooltip 600 may be activated through other means. For example, most input devices, such as a mouse, have various buttons ranging from one to more than 4 buttons and various scroll bars. Thus, any number of buttons, such as a right-click on a hot spot could also trigger the display of a tooltip 600. The information inside the tooltip may contain information about functionality of the corresponding hyperlink or any other type of information.

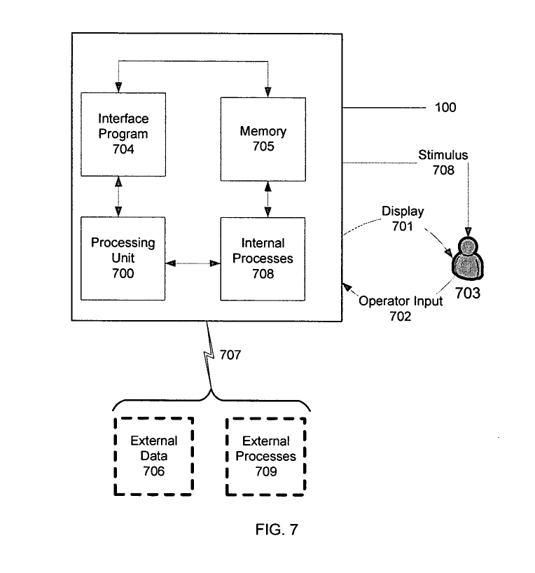

FIG. 7 depicts a system that could display an embodiment of the interface. A terminal 100 has a processing unit 700 that can run the interface program 704 taken from memory 705 in order to perform the various functions of the interface, including displaying the interface 701 to the operator, receiving operator input 702, initiating stimulus 708 to the operator 703, and accessing a communication medium 707 to send or receive commands from external processes 709 or external data 706. In instances where the embodiment accesses solely internal processes 708, communication need only be within the terminal 100. The external data 706 could include anything from database information accessed by the processing unit 700 to webpage data that could be displayed 701 to the operator 703.

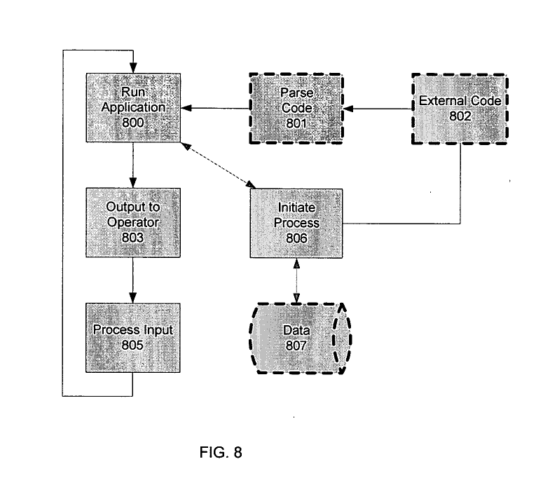

FIG. 8 depicts the high level logic of an embodiment of the interface. The interface application 800 outputs to the operator 803 a display and receives input 805. Based on this input, the application can output more information 803, such as a stimulus, or initiate a process 806 that may require accessing data 807. In the case of the interface being a web browser or a web application, the process 806 may send external code 802, such as a webpage, to be parsed by the application 801 in order to display new information to the operator 803.

Where the embodiment displays information from the internet, there is likely to be a standard format in order for the application to parse 801 and format the overloaded hyperlinks for use by the operator. Currently, there is a diverse set of languages that could be parsed and adapted by an embodiment of the interface to display overloaded hyperlinks. In a common markup language, hyperlinks can access resources and hyperlink information is placed between tags called anchors. In addition, style sheets could be used to give emphasis to the various link types.

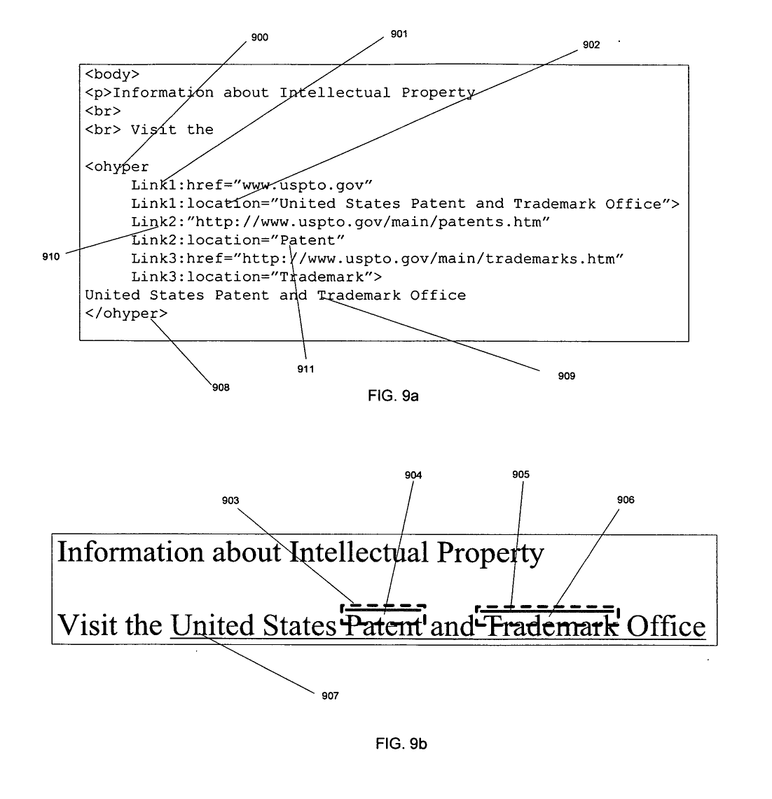

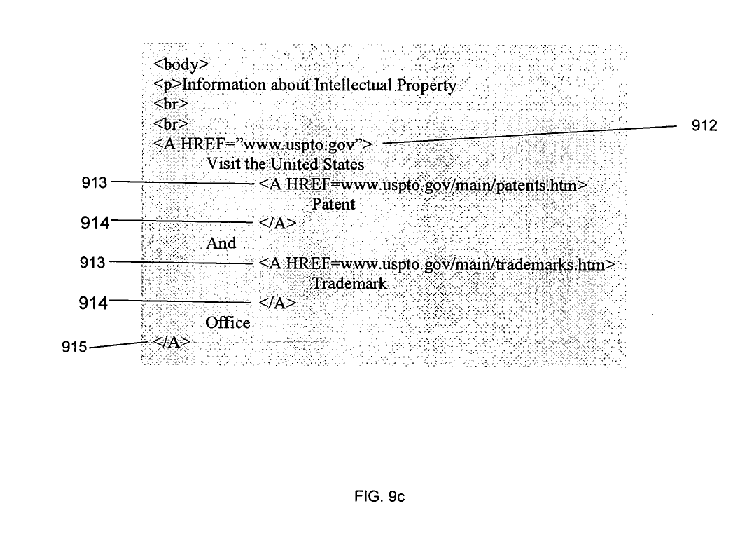

FIG. 9a provides a hypothetical markup language that could be parsed by an embodiment of the interface to display an overloaded hyperlink. The start of the overloaded hyperlink tag 900 is signified by the word “ohyper”. The tag contains multiple hyperlinks. The first hyperlink 901 displays the word “Link” followed by a number “1” signifying that it is the first hyperlink. The command “href” signifies that the link accesses a URL, though one skilled in the art would recognize that any number of processes or applications could be accessed by a hyperlink. The location of the first hyperlink 902 would typically be the textual sentence 909 found between the start tag and end tag 908. The second hyperlink 910 in this example also accesses a URL and the secondary hyperlink 910 lists a word 911 located within the context of the textual sentence 909 of the primary hyperlink. The interface can then associate the anchor of the second hyperlink within the textual sentence 909. One skilled in the art would realize that this is not the only format of code that could be parsed by the embodiment of the interface. There are many types of code and markup languages, such as XML, XLink, HTML, etc. that could be adapted for the embodiment or which the embodiment can be adapted to parse.

FIG. 9b displays a webpage with overloaded hyperlinks. The primary hyperlink 907 has blue font and is underlined to signify that it has functionality, in this case to access a URL. There is an overline 903 over the word “patent” and an overline 905 over the word “trademark” to signify that there is an overlapping hyperlink. The second hot spot 904 would recognize input to access the “patent” webpage and a tertiary hot spot 906 would recognize input to access the “trademark” webpage. Whereas an interface without overloaded hyperlinks would have required several clicks and calls to servers to request webpages, the embodiment condenses the transaction to a single overloaded hyperlink displayed on a single line and requiring a single input from an operator.

FIG. 9c depicts another variation of a hypothetical markup language that could be parsed by an embodiment of the interface to display an overloaded hyperlink. All the words between an initial hyperlink tag 912 and an end tag 915 would be in the first hyperlink display area. Thus, in the example, the words “Visit the United States Patent And Trademark Office” would have indicia to indicate that it has a hot spot area to access a first hyperlink. Nested tags are also placed within the first group of tags. Thus, words between initial tags 913 and end tags 914 of nested links would be used to represent secondary hyperlinks. Thus, in FIG. 9c, the words “Patent” and the words “Trademark” would both be associated with secondary hyperlinks.

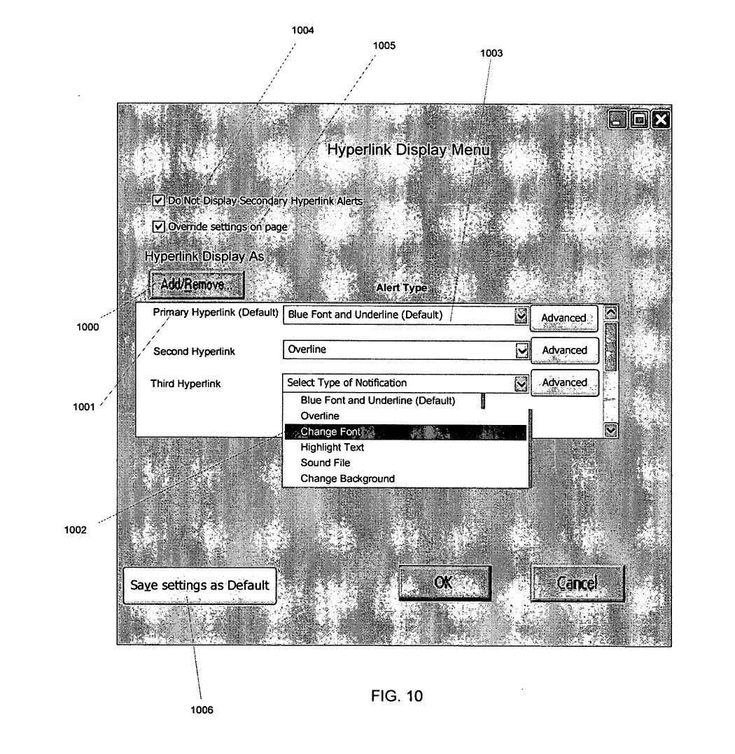

FIG. 10 provides a potential menu option for an operator to change emphasis options for the primary and secondary hyperlinks. In the context of a textual overloaded hyperlink, an operator may have the option of always having the hyperlink appears as originally provided by the interface designer or to override the settings on a particular page 1005 or to always have an operators' settings override that of the interface design by default 1006. As each hyperlink area may have multiple hyperlinks, an operator may have the option to set a number of hyperlinks 1000. In the figure, the primary hyperlink 1001 happens to be defaulted at blue font and underlined 1103 as is commonly found on the internet. A drop-down box 1002 provides an operator with some options to change the emphasis type. As the operator becomes more experienced with overloaded hyperlinks, the operator may choose not to have the extra emphasis displayed at all 1004. In certain instances, an interface designer may decide that the emphasis on certain pages should not be overridden by an operator's own preferences, in which case access to the hyperlink emphasis menu option could be grayed out to represent inaccessibility.

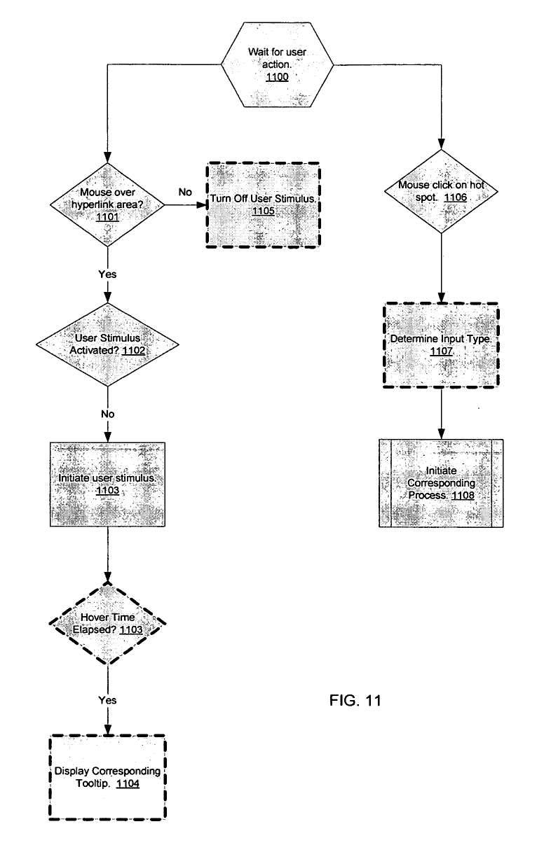

FIG. 11 depicts a logic flow that an embodiment of the interface might contain in order to process operator input and perform the proper actions. Initially the embodiment waits for an input from the mouse and will enter either Step 1101 or Step 1106.

At Step 1101 the embodiment has detected movement. If the embodiment determines the mouse is in the hyperlink area 1101 and the operator stimulus is not activated 1102 then the embodiment will initiate the operator stimulus 1103 corresponding to the hot spot in the hyperlink area. If the mouse is not over the hyperlink area the embodiment may choose to turn the operator stimulus off 1105. An exception to this is if a hot spot may extend outside of the hyperlink area, in which case the operator stimulus may still be activated. Alternatively, a UI designer may choose to leave this option out, or to already have the operator stimulus on in order to alert the operator to certain secondary hyperlinks. One skilled in the art will appreciate the flexibility of the embodiment as good UI design is adaptable for different applications, operators, and emphasis. For example, novice operators or children may need emphasis already activated, and it is desirable for certain emphasis to be turned on and off rather than perpetually on, such as for sound files.

In another embodiment of the interface, if there is a tooltip associated with any of the hyperlinks in the hyperlink area, the interface may determine if the operator has hovered the cursor or other input device over the hyperlink area for a predetermined time 1103. If so, the interface would display the tooltip corresponding to the hot spot the cursor is hovering over 1104.

If the embodiment detects that a mouse has clicked on a hot spot within a hyperlink area 1106, if there are multiple inputs corresponding to processes, the embodiment will determine which input was received 1107. The embodiment would activate the process corresponding to the hot spot activated by the operator input 1108.

Several embodiments of the present invention are specifically illustrated and described herein. However, it will be appreciated that modifications and variations of the present invention are covered by the above teachings and within the purview of the appended claims without departing from the spirit and intended scope of the invention.

I claim:

1. A method of providing a user interface, comprising:
displaying information content of the user interface, certain elements of the user interface representing hyperlinks,
displaying emphasis of a first hyperlink on a hyperlink display,
displaying emphasis of a second hyperlink on a portion of the hyperlink display, and
responsive to a selection of one of the first hyperlink and the second hyperlink, traversing the selected hyperlink to a network resource addressed therein.

2. The method according to claim 1, wherein multiple hyperlinks can be activated on the first hyperlink anchor by compound commands.

3. The method according to claim 1, wherein the hyperlink display is textual.

4. The method according to claim 3, wherein the emphasis is a line above the text.

5. The method according to claim 3, wherein the emphasis is highlighting of the text.

6. The method according to claim 1, wherein the emphasis is a non-default color applied to the hyperlink display.

7. The method according to claim 1, wherein the emphasis is a non-default background color.

8. The method according to claim 1, wherein the emphasis is a sound.

9. The method according to claim 3, wherein the emphasis is text different from the original textual display.

10. The method according to claim 1, wherein the first hyperlink has a corresponding first tooltip.

11. The method according to claim 1, wherein the second hyperlink has a corresponding second tooltip.

12. The method according to claim 10, wherein the first tooltip displays information regarding the functionality of the first hyperlink.

13. The method according to claim 11, wherein the second tooltip displays information regarding the functionality of the second hyperlink.

14. The method according to claim 1, wherein the first hyperlink display is multiplexed over time to access multiple processes.

15. The method according to claim 1, further comprising a third hyperlink overlapping a smaller portion of the primary hyperlink wherein the third hyperlink accesses a third computer process.

16. The method according to claim 15, wherein the third hyperlink has a corresponding third tooltip.

17. The method according to claim 16, wherein the third tooltip displays information regarding the functionality of the third hyperlink.

18. A user interface system, comprising:
an application capable of reading underlying code to associate hyperlinks areas with computer processes;
a display process capable of displaying hyperlinks;
an input device able to receive commands from an operator to click on a hyperlink;
a process able to associate an operator input with an activated hyperlink; and
an output process capable of accessing a computer process corresponding to the activated hyperlink and input signal.

19. The system according to claim 18, further comprising an output process to provide emphasis to alert the operator to the availability and location of multiple hyperlink functionality.

20. The system according to claim 19, wherein the emphasis stimulates the operator with visual signals.

21. The system according to claim 19, wherein the emphasis stimulates the operator with an audible sound.

22. The system according to claim 19, wherein the emphasis stimulates the operator with haptic feedback.

23. The system according to claim 19, wherein the emphasis stimulates the operator with signals olfactory in nature.

24. The system according to claim 19, wherein the operator can adjust the emphasis output.

25. The system according to claim 18, wherein the hyperlink is textual.
